(19) United States
(12) Patent Application Publication
(10) Pub. No.: US 2014/0115482 A1
(43) Pub. Date: Apr. 24, 2014

(54) METHOD FOR DISPLAYING AN OVERLAID WEB SURVEY ICON

(71) Applicant: IPERCEPTIONS INC., Westmount (CA)

(72) Inventor: Valentin PETKOV, Montreal (CA)

(73) Assignee: IPERCEPTIONS INC., Westmount (CA)

(21) Appl. No.: 13/654,837

(22) Filed: Oct. 18, 2012

(51) Int. Cl. G06F 3/0481

(52) U.S. Cl. CPC G06F 3/04817
USPC 715/738

(57) ABSTRACT

The present relates to a computer-implemented method for displaying an overlaid web survey icon. The method displays a content of a web site in a browsing window of a browser of an electronic device. The method displays an invitation to participate in a survey. The method displays, upon selection of the invitation to participate in the survey by a user, an overlaid survey icon in the browsing window. And the method further displays the overlaid survey icon in the browsing window, when another content of the web site is displayed in the browsing window. Upon occurrence of a triggering event, the method displays a survey content in a survey window. In one embodiment, the triggering event consists in a selection by the user of the overlaid survey icon.

### TECHNICAL FIELD

The present disclosure relates to user interactions with a web survey related to a web site; and more particularly to a display of an overlaid web survey icon.

### BACKGROUND

The usage of web sites to make dedicated web content available to a large public is more and more widespread, with the development of fixed Internet access and mobile Internet access. In several contexts (including e-commerce, professional and administrative web sites, etc), there is a growing need for the owners of the web sites to better understand whether the users are satisfied with their interactions with the web sites, and with the content available on the web sites. And further to determine the interests of the users with respect to topics in relation to the content displayed in the web sites. One way to obtain such information is to have the users answer a web survey before, during, or after the browsing of the web sites.

In a first step, at some point during the browsing of a web site (beginning, middle, end), a user is asked (via a graphical user interaction) whether he accepts to answer a web survey related to the web site.

Then, an usual way to perform the survey is to open a survey window, download the content of the web survey from a survey server, display the content of the web survey in the survey window, and have the user interact with the content of the web survey (answer the questions of the survey in the general case).

However, if the user accepts to answer the survey while he has just started browsing the web site, he may want to continue browsing the web site, and answer the survey later. FIGS. 1A to 1C illustrate this situation, representing an usual way of displaying a survey window. FIG. 1A illustrates the situation where a user started browsing the web site www.ecommerce.com (as illustrated in the URL bar 110 of a browser 100). The browser 100 displays a content (for example the home page) of the web site www.ecommerce.com in a browsing window 120 of the browser 100. Then, an invitation to answer a survey is displayed; and the user accepts the invitation. This step is not represented in FIG. 1A for simplification purposes. Upon acceptance by the user of the invitation to answer the survey, a survey window 122 is displayed in the browser 100, as illustrated in FIG. 1B. The browsing window 120 represented in FIG. 1A is hidden, and a tab 130 corresponding to the browsing window 120 is displayed. A tab 132 corresponding to the survey window 122 is also displayed. The user may decide to answer the survey later, and come back to the browsing window 120, by selecting the tab 130. FIG. 1C illustrates this situation, where the user is back browsing the web site www.ecommerce.com in the browsing window 120. At some point, the user may decide to answer the survey, by selecting the tab 132. The survey window 122 is then displayed by the browser 100, as illustrated in FIG. 1B.

The aforementioned method of using tabs for switching between a browsing window and a survey window in a browser may not be considered user friendly by many users. And it may even discourage certain users to effectively answer a survey, even after having accepted an invitation to answer the survey. Furthermore, in the case of a mobile device like a smartphone, the browser usually does not use tabs. Therefore, the aforementioned method cannot be implemented in the case of a smartphone.

There is therefore a need for improving the user interactions with a web survey related to a web site

### SUMMARY

According to a first aspect, the present disclosure provides a computer-implemented method for displaying an overlaid web survey icon. For doing so, the method comprises displaying a content of a web site in a browsing window of a browser of an electronic device. The method further comprises displaying an invitation to participate in a survey. Then, the method comprises displaying, upon selection of the invitation to participate in the survey by a user, an overlaid survey icon in the browsing window. And the method comprises further displaying the overlaid survey icon in the browsing window, when another content of the web site is displayed in the browsing window.

According to a second aspect, the present disclosure provides a computer program product deliverable via computer-readable media such as storage media and communication links. The computer program product comprises instructions for displaying an overlaid web survey icon. The instructions, when executed by a processor, effect a display of a content of a web site in a browsing window of a browser of an electronic device. The instructions further effect a display of an invitation to participate in a survey. Then, the instructions effect a display, upon selection of the invitation to participate in the survey by a user, of an overlaid survey icon in the browsing window. And the instructions effect a further display of the overlaid survey icon in the browsing window, when another content of the web site is displayed in the browsing window.

In a particular aspect, displaying a content of a web site in a browsing window of a browser of an electronic device consists in displaying a first webpage of the web site in the browsing window. Displaying, upon selection of the invitation to participate in the survey by a user, an overlaid survey icon in the browsing window consists in displaying the survey icon overlaid over the first webpage of the web site displayed in the browsing window. And further displaying the overlaid survey icon in the browsing window, when another content of the web site is displayed in the browsing window, consists in displaying the survey icon overlaid over another webpage of the web site, when the other webpage of the web site is displayed in the browsing window.

In another particular aspect, upon selection of the invitation to participate in the survey by the user, an indication that the user selected the invitation to participate in the survey is stored in a cookie of the web site. And when a webpage of the web site is displayed in the browsing window, if the cookie of the web site contains the indication that the user selected the invitation to participate in the survey, the survey icon is displayed overlaid over the webpage of the web site displayed in the browsing window.

In a particular aspect, upon occurrence of a triggering event, a survey content is displayed in a survey window.

In another particular aspect, the triggering event consists in a selection by the user of the overlaid survey icon.

In yet another particular aspect, the triggering event consists in one of: an indication that the user leaves the web site, an indication of a closing of the browser.

The foregoing and other features of the present computer-implemented method and computer program product will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIGS. 1A to 1C illustrate an usual way of displaying a survey window;

FIG. 2 illustrates a computer-implemented method for displaying an overlaid web survey icon, according to a non-restrictive illustrative embodiment;

FIGS. 3A to 3G illustrate a display by a browser of an electronic device of an overlaid web survey icon, according to a non-restrictive illustrative embodiment; and

FIG. 4 illustrates an electronic device for executing a computer program product for displaying an overlaid web survey icon, according to a non-restrictive illustrative embodiment.

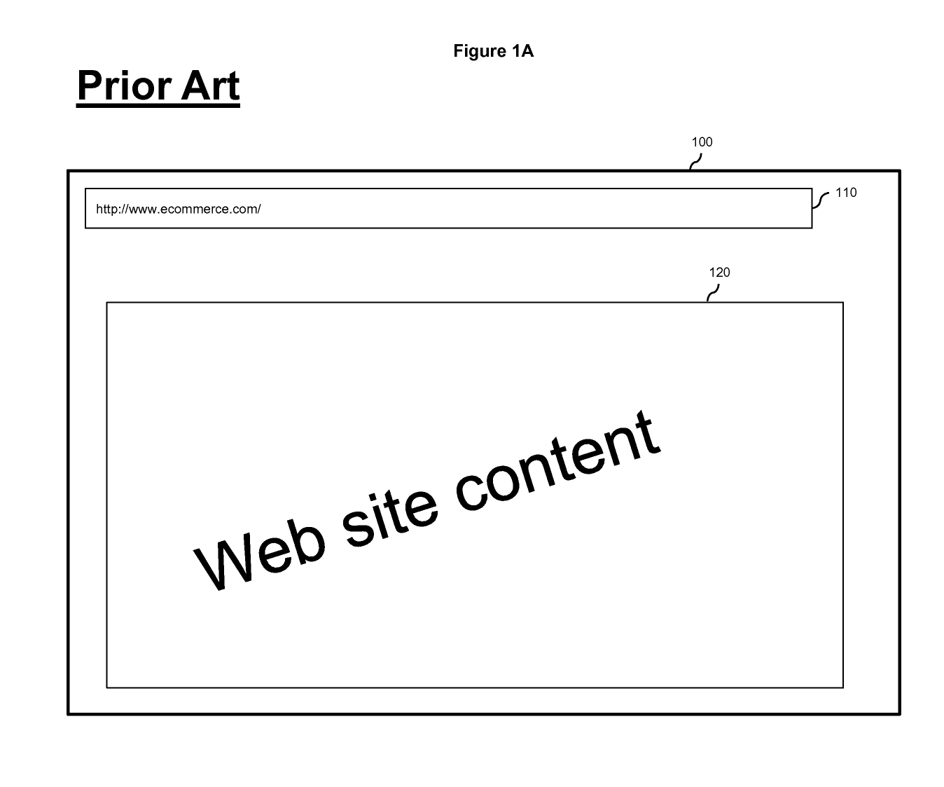

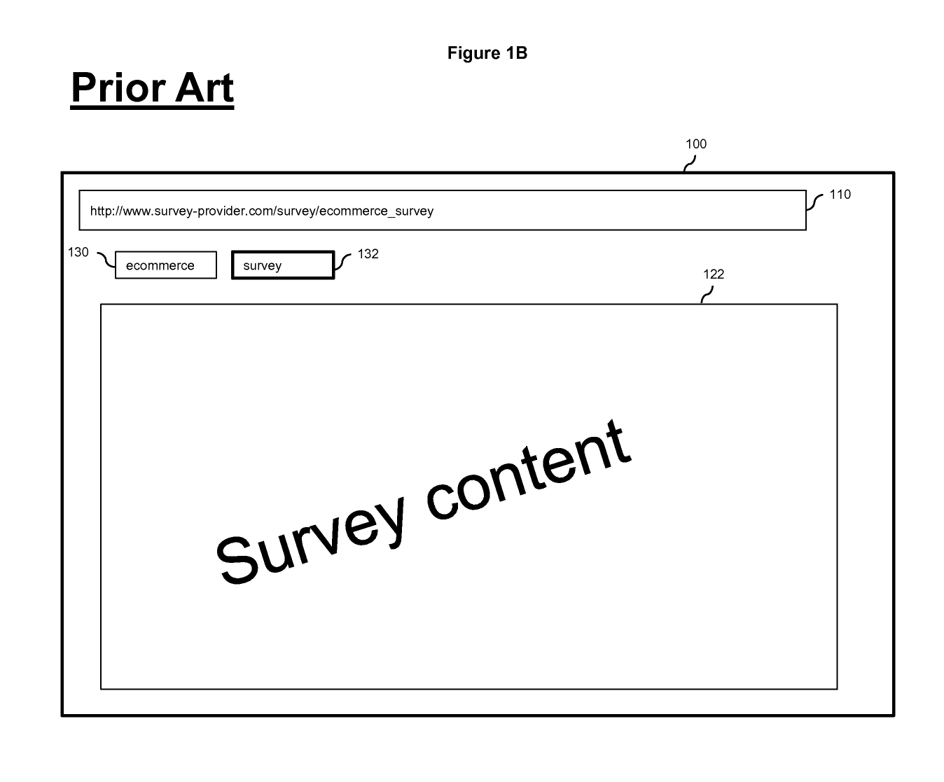

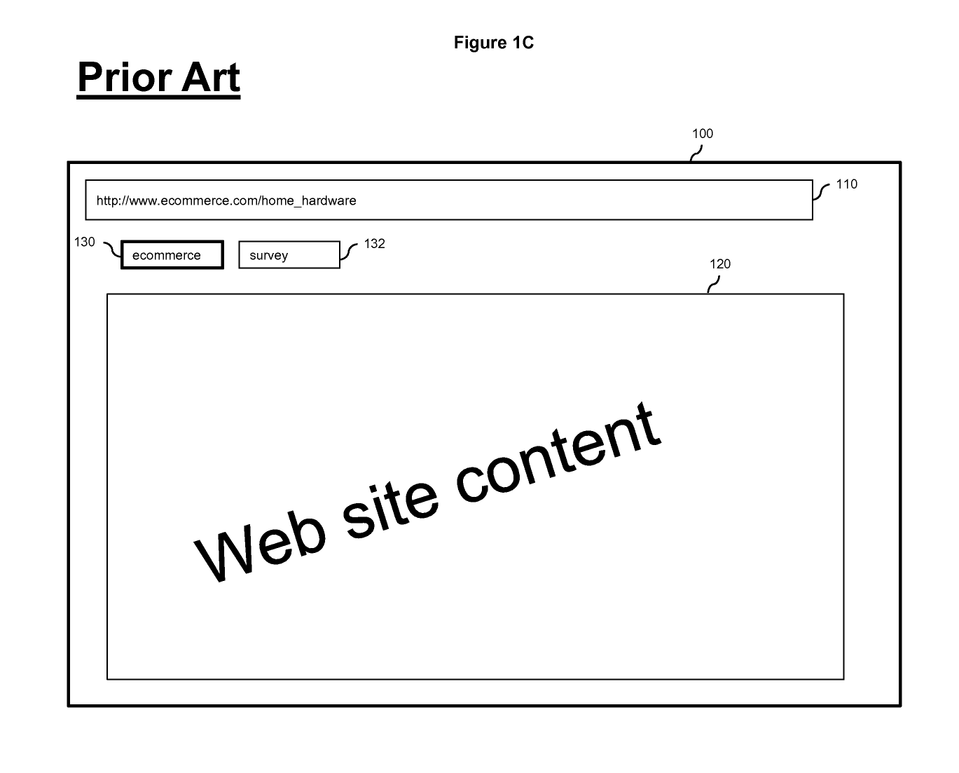

### DETAILED DESCRIPTION

To better understand the present specification, the following definitions are provided.

The term survey is used in a generic manner, referring to a means of obtaining feedback from users; and may include surveys, questionnaires, comment cards, etc. The term survey means a web survey in the context of the present disclosure. And the survey aims at collecting user feedback related to the browsing of a web site by a user.

The present disclosure relates to a computer-implemented method for displaying an overlaid web survey icon.

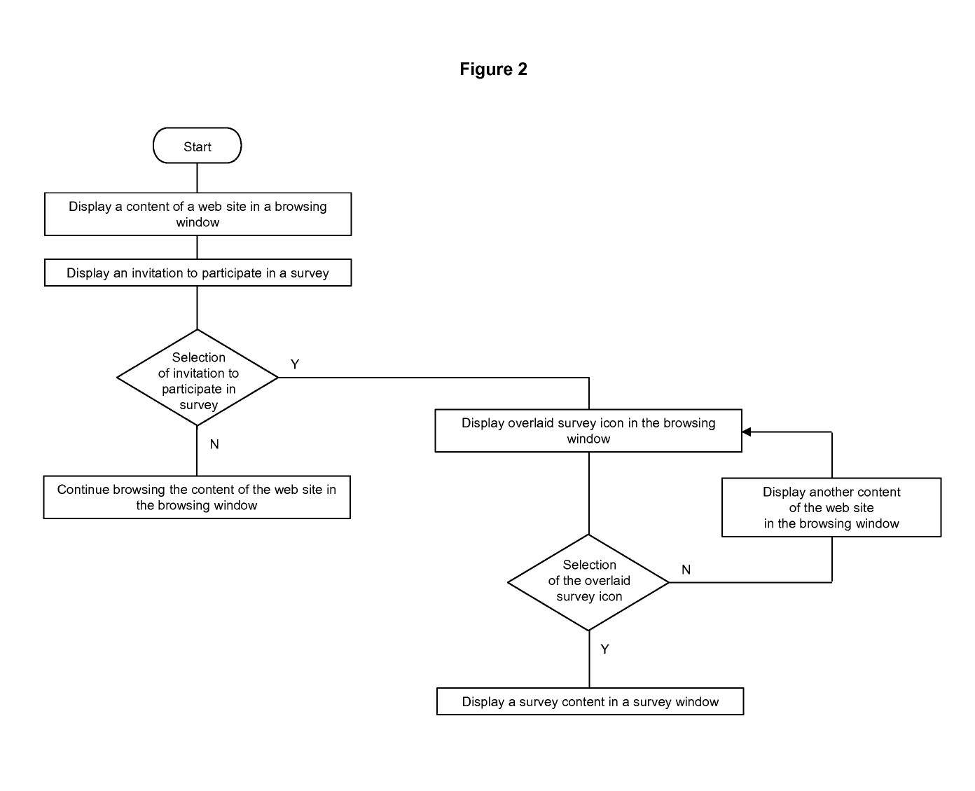

Reference is now made to FIG. 2, which illustrates the aforementioned computer-implemented method.

The method comprises displaying a content of a web site in a browsing window of a browser of an electronic device. The method further comprises displaying an invitation to participate in a survey. Then, the method comprises displaying, upon selection of the invitation to participate in the survey by a user, an overlaid survey icon in the browsing window. And the method comprises further displaying the overlaid survey icon in the browsing window, when another content of the web site is displayed in the browsing window.

Examples of electronic devices include computers, laptops, mobile devices (e.g. smartphones, tablets, etc), Internet connected televisions. The electronic device includes networking means for retrieving web content from the Internet, and means for displaying the retrieved web content via a browser.

The browsing window is a window displayed by the browser of the electronic device, on a display of the electronic device. The web content of the web site is displayed in the browsing window.

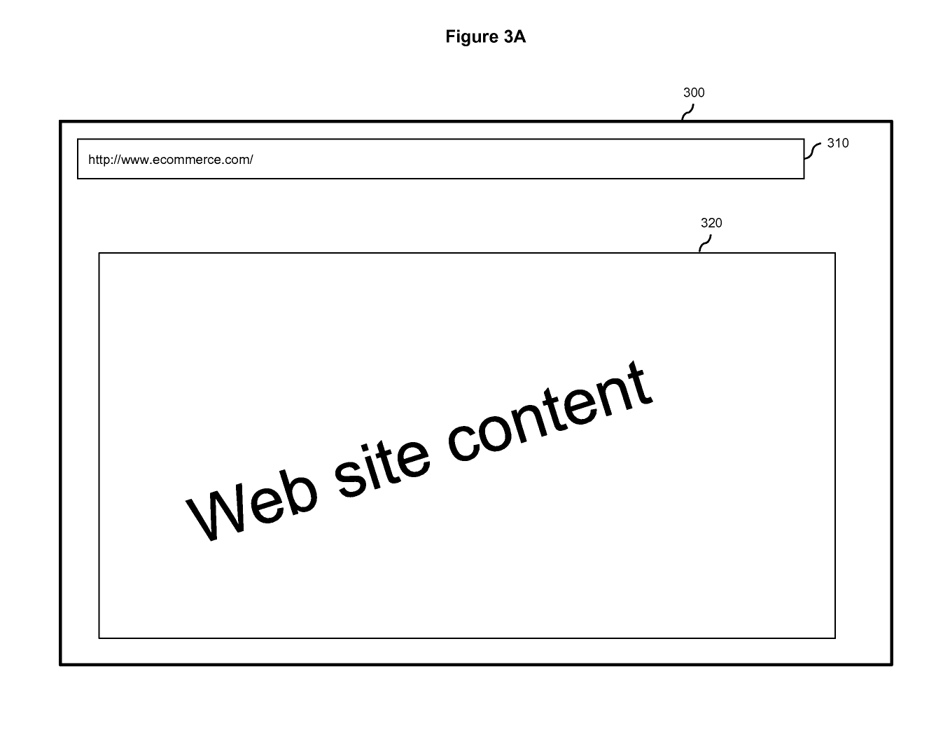

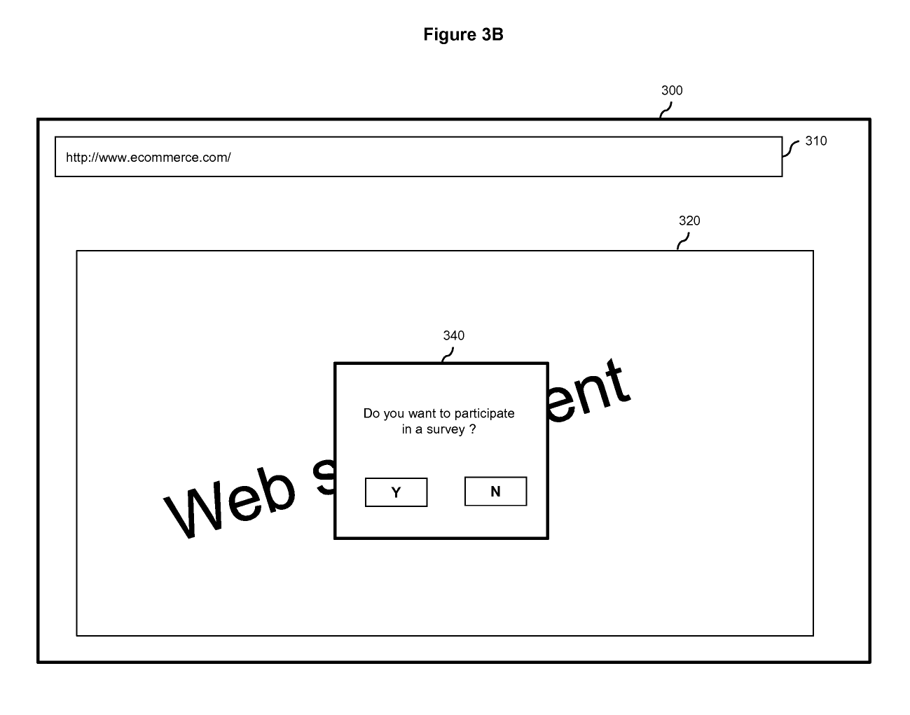

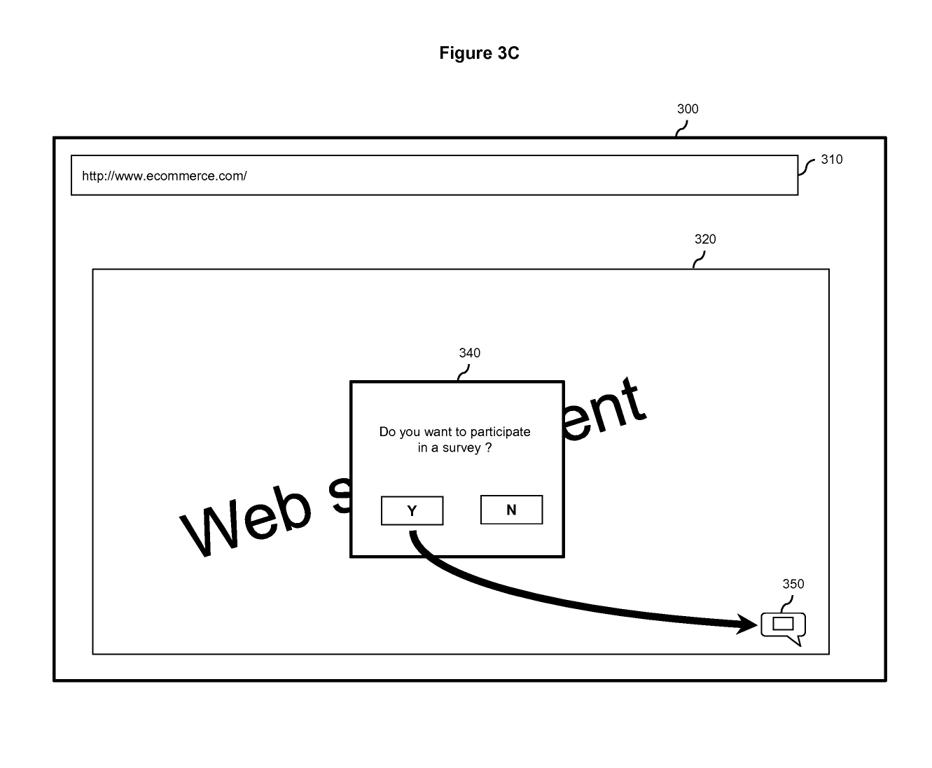

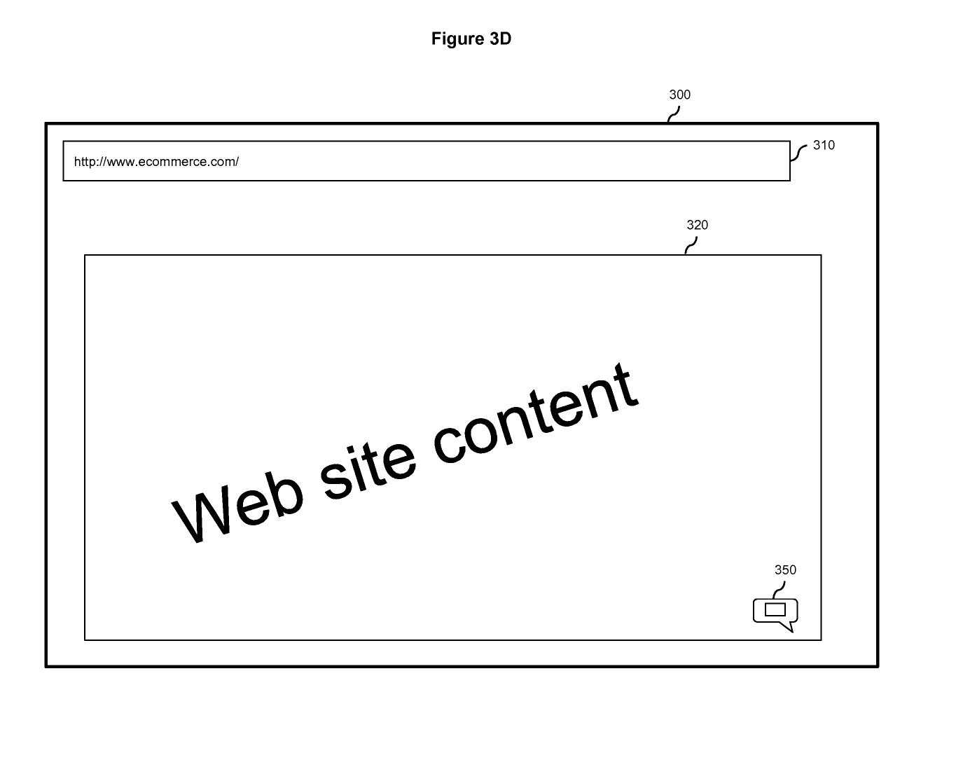

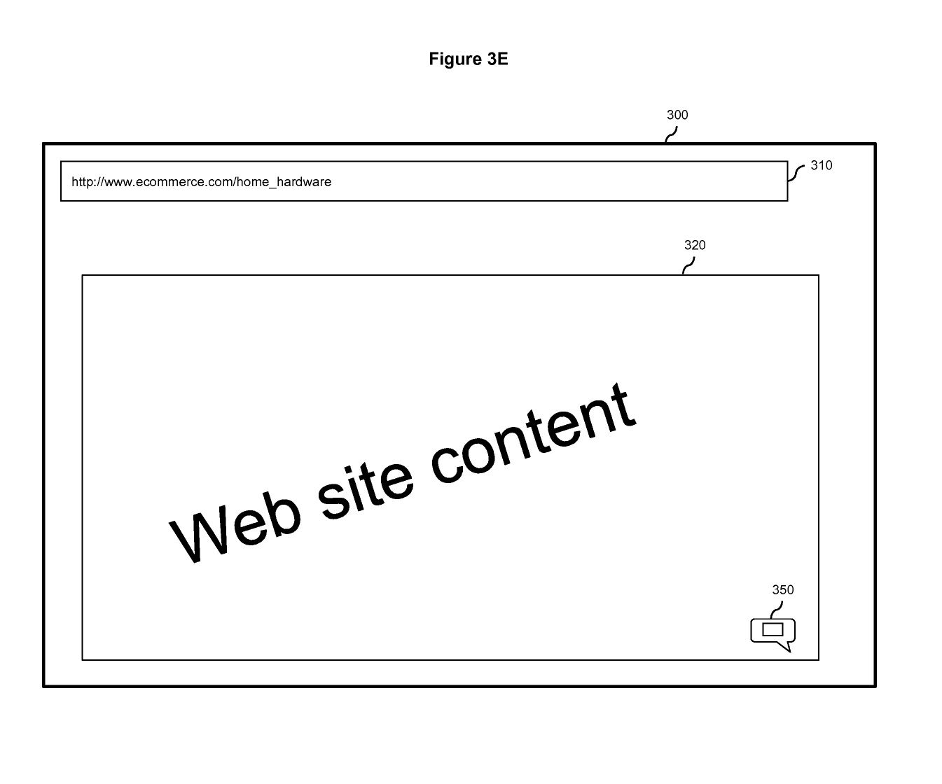

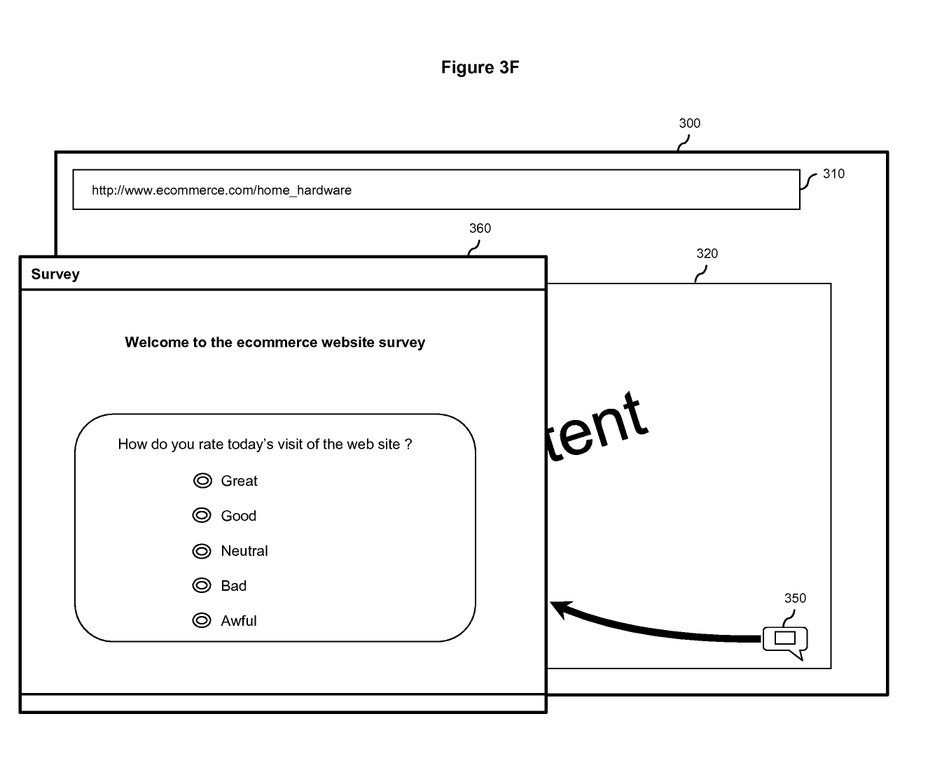

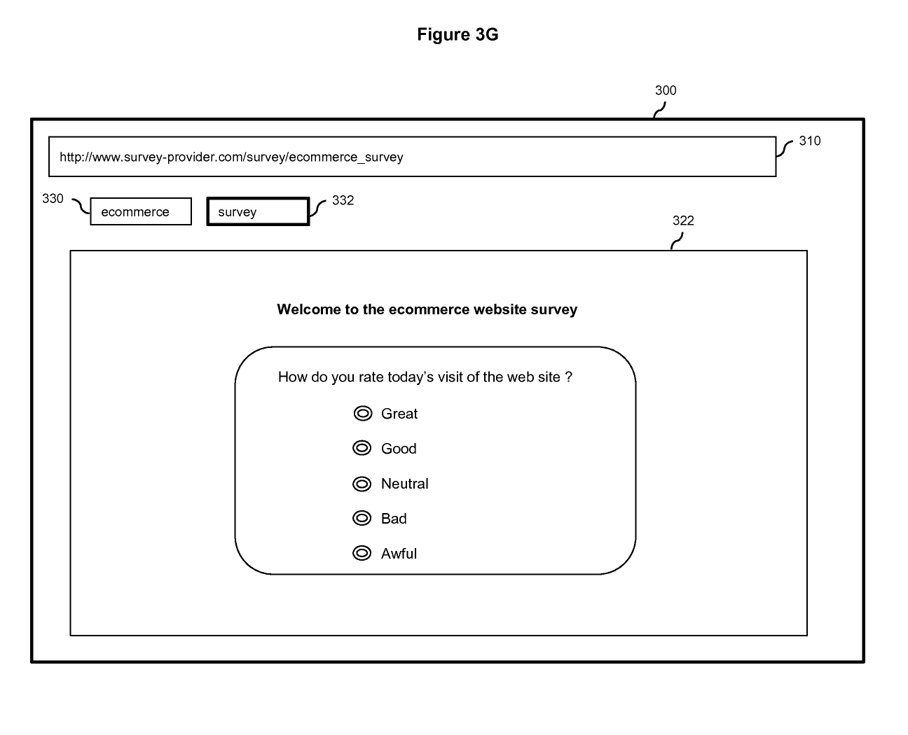

The invitation to participate in a web survey (related to the web site) is displayed when a specific content of the web site is displayed. This specific content has been pre-defined as a trigger, for displaying the invitation to participate in the survey. For example, the specific content may be the home page of the web site, or a landing webpage of the web site from a referrer web site. Thus, the invitation may be displayed at the beginning, or during the browsing of the web site. The invitation may be displayed, for example, in an overlay popup window of the browsing window; as will be illustrated later in the description, in relation to FIG. 3B. The invitation may be displayed by means of any graphical user interaction known in the art.

If the user refuses the invitation to participate in the survey, the browsing of the content of the web site continues in the browsing window, as usual.

If the user accepts the invitation to participate in the survey (referred to as a selection of the invitation to participate in the survey in the present disclosure), an overlaid survey icon is displayed in the browsing window. The overlaid survey icon will be illustrated later in the description, in relation to FIGS. 3C to 3F. An overlaid icon is well known in the art. It consists of an icon, which is displayed on top of a graphical resource. When the content displayed in the graphical resource changes, the icon remains displayed on top of the content. In the present disclosure, the graphical resource is the browsing window of the browser, where the content of the web site currently browsed by the user is displayed. Thus, the overlaid survey icon remains displayed in the browsing window, when another content of the web site is displayed in the browsing window The overlaid survey icon may be positioned anywhere within the browsing window.

In an embodiment of the present method, the content of the web site displayed in the browsing window consists of webpages of the web site. And the method comprises the steps of: displaying a first webpage of the web site in the browsing window; displaying, upon selection of the invitation to participate in the survey by a user, the survey icon overlaid over the first webpage of the web site displayed in the browsing window; and displaying the survey icon overlaid over another webpage of the web site, when the other webpage of the web site is displayed in the browsing window.

In another embodiment of the present method, upon selection of the invitation to participate in the survey by the user, an indication that the user selected the invitation to participate in the survey is stored in a cookie of the web site. And when a webpage of the web site is displayed in the browsing window, if the cookie of the web site contains the indication that the user selected the invitation to participate in the survey, the survey icon is displayed overlaid over the webpage of the web site displayed in the browsing window. A cookie is well known in the art. It allows the storage of information related to a web site. The cookie is available for each webpage of the web site displayed in the browsing window of the browser. Thus, an information recorded in the cookie (selection of the invitation to participate in the survey by the user) during the display of a specific webpage of the web site, is further available during the display of any other webpage of the web site; allowing an action (the display of the overlaid survey icon) to be executed based on the presence of the information in the cookie.

In a particular aspect of the present method, a display of a survey content in a survey window is triggered by a triggering event. Several types of triggering events may cause the display of the survey content in the survey window. Exemplary embodiments of a survey window for displaying a survey content will be illustrated later in the description, in relation to FIGS. 3F and 3G. The content of the survey displayed in the survey window is provided by a third party provider; for example via a survey server hosting the survey content to be displayed for the particular web site displayed in the browsing window.

In a particular embodiment of the present method, the triggering event consists in a selection by the user of the overlaid survey icon. A selectable icon (which can be selected by the user via a user interaction with the icon) is well known in the art. It will be further illustrated later in the description, in relation to FIG. 3F.

In another particular embodiment of the present method, the triggering event may consists of: an indication that the user leaves the web site, or an indication of a closing of the browser. For example, a dedicated script embedded in the webpages displayed in the browsing window may be executed by the browser. The dedicated script intercepts browser events corresponding to an indication that the user leaves the web site, or an indication of a closing of the browser. Upon occurrence of one of these events, the dedicated script triggers the display of the survey content in the survey window.

Referring now to FIGS. 3A to 3G concurrently, a display by a browser of an electronic device of an overlaid web survey icon, according to an exemplary embodiment of the aforementioned computer-implemented method, is illustrated.

FIG. 3A represents the display by the browser 300 of the electronic device of a browsing window 320 of a web site (www.ecommerce.com for illustration purposes). The content of a webpage of the web site is displayed in the browsing window 320. For illustration purposes, the webpage is the home page of the web site www.ecommerce.com, as represented in an URL bar 310 of the browser 300.

Referring now to FIG. 3B, an invitation 340 to participate in a survey (related to the web site www.ecommerce.com) is displayed. For illustration purposes, the invitation 340 is an overlay popup window of the browsing window 320.

Referring now to FIG. 3C, upon selection of the invitation 340 by a user of the electronic device, an overlaid survey icon 350 is displayed in the browsing window 320. In the context of the present disclosure, a selection of the invitation to participate in the survey means: indicating via a user interaction that the user accepts to participate in the survey. For example, as illustrated in FIG. 3C, the user selects the option “Y” (e.g. via a mouse click) displayed in the invitation 340.

Although the overlaid survey icon 350 is displayed (for illustration purposes only) in the lower right corner of the browsing window 320, it may be displayed anywhere within the browsing window 320. Further, displaying the overlaid survey icon 350 in the browsing window 320 shall be interpreted broadly. It means effectively inside the browsing window 320. Or close enough to the browsing window 320, to make it clear for the user that the overlaid survey icon 350 is related to the content of the web site displayed in the browsing window 320.

Referring now to FIG. 3D, the user resumes its visit to the web site where he left it. The invitation 340 to participate in the survey (represented in FIG. 3C) is closed. The overlaid survey icon 350 is displayed in the browsing window 320, as a reminder that the user has accepted to participate in the survey. And the user may return to the content of the webpage displayed in the browsing window 320 (it is the same webpage and the same content as in FIGS. 3A, 3B, and 3C).

Referring now to FIG. 3E, a new webpage (with a new content) is displayed in the browsing window 320. For illustration purposes, the webpage is www.ecommerce.com/home_hardware, as represented in the URL bar 310. The overlaid survey icon 350 is displayed in the browsing window 320, as a reminder that the user has accepted to participate in the survey.

Referring now to FIG. 3F, the user decides to start the survey. The overlaid survey icon 350 is a selectable icon. Thus, the user selects the overlaid survey icon 350 to effectively start the survey. In one embodiment, selecting the overlaid survey icon 350 consists in positioning a pointer (not represented in FIG. 3F) on the icon 350; and selecting the icon 350 with the pointer. In the case of an electronic device with a touchscreen, the pointer is controlled by the finger (selection of the icon 350 via a position and press movement of the finger) of the user. In the case of an electronic device with a mouse, the pointer is controlled by the mouse (selection of the icon 350 via a position and click action of the mouse). Upon selection of the overlaid survey icon 350 by the user, a survey window 360 is opened by the browser 300. And a content related to the survey is displayed in the survey window 360.

FIG. 3F represents an exemplary embodiment of the survey window 360. The survey window 360 is an overlay window, displayed on top of the browser 300 containing the browsing window 320. The content of the survey window 360 may be downloaded from a server of a third party implementing the survey. For example, the survey window is created with an URL matching the third party (e.g. www.survey-povider.com) and the web site (www.ecommerce.com) displayed in the browsing window 320: www.survey-provider.com/survey/ecommerce_survey. And webpages corresponding to the survey are downloaded from the server and displayed in the survey window 360. When the survey is completed, the survey window 360 is closed; and the user may resume the browsing (of the current web site or another web site) in the browsing window 320 of the browser 300 (as represented in FIG. 3A).

FIG. 3G represents another exemplary embodiment of a survey window 322. The survey window 322 is displayed in the browser 300, as a new tab 332. The browsing window 320 (represented in FIGS. 3A to 3E) is associated to another tab 330. The execution of the survey in the survey window 322 of FIG. 3G is similar to the execution of the survey in the survey window 360 of FIG. 3F. When the survey is completed, the survey window 322 is closed by the user (as well as the corresponding tab 332); and the user may resume the browsing (of the current web site or another web site) in the browsing window 320 of the browser 300 (as represented in FIG. 3A).

The present disclosure also relates to a computer program product deliverable via computer-readable media such as storage media and communication links. The computer program product may be executed on an electronic device. The computer program product implements the steps of the aforementioned computer-implemented method for displaying an overlaid web survey icon.

The computer program product comprises instructions for displaying an overlaid web survey icon. The instructions, when executed by a processor, effect a display of a content of a web site in a browsing window of a browser of an electronic device. The instructions further effect a display of an invitation to participate in a survey. Then, the instructions effect a display, upon selection of the invitation to participate in the survey by a user, of an overlaid survey icon in the browsing window. And the instructions effect a further display of the overlaid survey icon in the browsing window, when another content of the web site is displayed in the browsing window.

In a particular aspect of the computer program product, displaying a content of a web site in a browsing window of a browser of an electronic device consists in displaying a first webpage of the web site in the browsing window. Displaying, upon selection of the invitation to participate in the survey by a user, an overlaid survey icon in the browsing window consists in displaying the survey icon overlaid over the first webpage of the web site displayed in the browsing window. And further displaying the overlaid survey icon in the browsing window, when another content of the web site is displayed in the browsing window, consists in displaying the survey icon overlaid over another webpage of the web site, when the other webpage of the web site is displayed in the browsing window.

In another particular aspect of the computer program product, upon selection of the invitation to participate in the survey by the user, an indication that the user selected the invitation to participate in the survey is stored in a cookie of the web site. And when a webpage of the web site is displayed in the browsing window, if the cookie of the web site contains the indication that the user selected the invitation to participate in the survey, the survey icon is displayed overlaid over the webpage of the web site displayed in the browsing window.

In a particular aspect of the computer program product, upon occurrence of a triggering event, the instructions effect a display of a survey content in a survey window.

In another particular aspect of the computer program product, the triggering event consists in a selection by the user of the overlaid survey icon.

In yet another particular aspect of the computer program product, the triggering event consists in one of: an indication that the user leaves the web site, an indication of a closing of the browser.

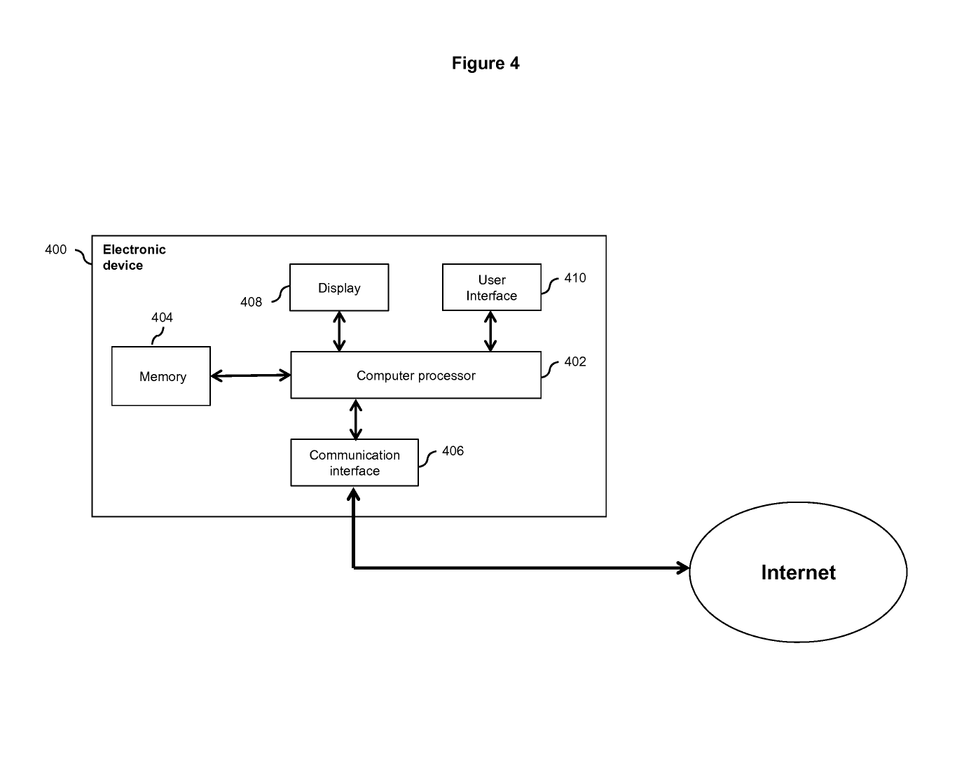

Referring now to FIG. 4, an electronic device for executing a computer program product for displaying an overlaid web survey icon is represented.

The electronic device 400 represented in FIG. 4 includes a processor 402, a memory 404, a communication interface 406, a display 408, and a user interface 410.

The processor 402 executes instructions comprised in the computer program for displaying an overlaid web survey icon. The computer program is stored in the memory 404. The computer program may be delivered to the electronic device 400 via a computer-readable media (e.g. a storage media), or via communication links (e.g. Internet) using the communication interface 406.

The browsing window (with the content of the web site), the overlaid survey icon, and the survey window (with the survey content) are displayed on the display 408, via a browser.

A user of the electronic device 400 may interact with the electronic device 400 via the user interface 410 (e.g. a mouse, a keyboard, a touch-screen). The interactions include the selection of the invitation to participate in the survey, and the selection of the overlaid survey icon.

The communication interface 406 allows the electronic device 400 to communicate with the Internet, in order to retrieve the content of the web site to be displayed in the browsing window, and the survey content to be displayed in the survey window.

Although the present disclosure has been described in the foregoing description by way of illustrative embodiments thereof, these embodiments can be modified at will, within the scope of the appended claims without departing from the spirit and nature of the appended claims.

What is claimed is:

1. A computer-implemented method for displaying an overlaid web survey icon, the method comprising:
displaying a content of a web site in a browsing window of a browser of an electronic device;
displaying an invitation to participate in a survey;
displaying, upon selection of the invitation to participate in the survey by a user, an overlaid survey icon in the browsing window; and
further displaying the overlaid survey icon in the browsing window when another content of the web site is displayed in the browsing window.

2. The computer-implemented method of claim 1, wherein
displaying a content of a web site in a browsing window of a browser of an electronic device consists in displaying a first webpage of the web site in the browsing window;
displaying, upon selection of the invitation to participate in the survey by a user, an overlaid survey icon in the browsing window consists in displaying the survey icon overlaid over the first webpage of the web site displayed in the browsing window; and
further displaying the overlaid survey icon in the browsing window when another content of the web site is displayed in the browsing window consists in displaying the survey icon overlaid over another webpage of the web site when the other webpage of the web site is displayed in the browsing window.

3. The computer-implemented method of claim 2, wherein upon selection of the invitation to participate in the survey by the user, an indication that the user selected the invitation to participate in the survey is stored in a cookie of the web site; and when a webpage of the web site is displayed in the browsing window, if the cookie of the web site contains the indication that the user selected the invitation to participate in the survey, the survey icon is displayed overlaid over the webpage of the web site displayed in the browsing window.

4. The computer-implemented method of claim 1, wherein upon occurrence of a triggering event, a survey content is displayed in a survey window.

5. The computer-implemented method of claim 4, wherein the triggering event consists in a selection by the user of the overlaid survey icon.

6. The computer-implemented method of claim 4, wherein the triggering event consists in one of: an indication that the user leaves the web site, an indication of a closing of the browser.

7. A computer program product deliverable via computer-readable media such as storage media and communication links, the computer program product comprising instructions for displaying an overlaid web survey icon that when executed by a processor effect:
a display of a content of a web site in a browsing window of a browser of an electronic device;
a display of an invitation to participate in a survey;
a display, upon selection of the invitation to participate in the survey by a user, of an overlaid survey icon in the browsing window; and
a further display of the overlaid survey icon in the browsing window when another content of the web site is displayed in the browsing window.

8. The computer program product of claim 7, wherein
a display of a content of a web site in a browsing window of a browser of an electronic device consists in a display of a first webpage of the web site in the browsing window;
a display, upon selection of the invitation to participate in the survey by a user, of an overlaid survey icon in the browsing window consists in a display of the survey icon overlaid over the first webpage of the web site displayed in the browsing window; and
a further display of the overlaid survey icon in the browsing window when another content of the web site is displayed in the browsing window consists in a display of the survey icon overlaid over another webpage of the web site when the other webpage of the web site is displayed in the browsing window.

9. The computer program product of claim 8, wherein upon selection of the invitation to participate in the survey by the user, an indication that the user selected the invitation to participate in the survey is stored in a cookie of the web site; and when a webpage of the web site is displayed in the browsing window, if the cookie of the web site contains the indication that the user selected the invitation to participate in the survey, the survey icon is displayed overlaid over the webpage of the web site displayed in the browsing window.

10. The computer program product of claim 7, wherein upon occurrence of a triggering event, the instructions effect a display of a survey content in a survey window.

11. The computer program product of claim 10, wherein the triggering event consists in a selection by the user of the overlaid survey icon.

12. The computer program product of claim 10, wherein the triggering event consists in one of: an indication that the user leaves the web site, an indication of a closing of the browser.
